(19) United States
(12) Patent Application Publication
(10) Pub. No.: US 2021/0402935 A1
(43) Pub. Date: Dec. 30, 2021

(54) License plate covers and related methods

(71) Applicant: Nikolay Reshetnyak, Moscow (RU)

(72) Inventor: Nikolay Reshetnyak, Moscow (RU)

(21) Appl. No.: 17/343,831

(22) Filed: Jun. 10, 2021

Related U.S. Application Data
(62) Division of application No. 29/695,201, filed on Jun. 17, 2019, now Pat. No. D928677.

(51) Int. Cl. B60R 13/10

(52) U.S. Cl. CPC B60R 13/105

(57) ABSTRACT

Disclosed is a durable weather resistant license plate frame that is made of silicone.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of covers for license plates.

### Background of the Invention

Every automobile, including cars and motorcycles are required by law to display a license plate. Most license plates are government issue and are defined by a plate of metal that has sharp edges and that is unattractive. To cover the edges and to increase aesthetics of the plate people have put various frames around the license plate of their vehicle. Unfortunately, many of these frames are not ideal in operation because they are easily damaged, rattle while the automobile is in motion and can fade in color over time to the point of not matching the paintjob of the automobile. Furthermore, known frames can melt, crack, or freeze-over depending on the weather conditions.

### SUMMARY OF THE INVENTION

In view of the foregoing, an object of this specification is to disclose a durable weather resistant license plate frame that is made of silicone. The frame also features drainage holes for water to drain. The benefits of this disclosed frame are that the material allows the frame to be durable, not rattle, not rust, and not lose its shape under extreme weather conditions.

### LISTING OF RELATED ART

U.S. Pat. No. 3,755,945 to McEwen et al. (1973) discloses a license plate holder that is “constructed of a semi-flexible, tough, non-tearable material such as polyethylene plastic.”

U.S. Pat. No. 4,891,895 to DeLaquil, Jr. (1990) discloses a license plate holder for providing a weather-proof enclosure.

U.S. Pat. No. 7,383,649 to MacNeil (2008) discloses an elastomeric gasket and a frame made from “a tough plastic material, such as an acrylic or polycarbonate.”

U.S. Pat. No. 9,463,755 to Kreft (2016) discloses a flexible license plate mount made from ethylene propylene diene M-class rubber (EPDM), which has very good heat, ozone, and weather resistance.

U.S. Pat. No. 9,586,538 to Fontayne (2017) discloses a license plate holder that has a body made of rubber, polychloroprene, nitrile, nitrile butadiene rubber, cyanocarbons, styrene butadiene rubber, ethylene propylene rubber.

US Pub. Pat. App. Ser. No. 2014/0373403 to Mendoza (Dec. 25, 2014) discloses a license plate wrap that is comprised of a waterproof plastic material that is flexible and is configured to contour to the surface of a bumper, such as a vinyl laminate material.

BumpTek BumperArmor, which is a flexible rubber license plate frame.

Pilot Automotive, which is a stretchable license frame made from soft urethane.

WeatherTech sells a BumpFrame license plate frame that is a soft bumper material molded over high impact polycarbonate.

SSW Dealer Supply sells a “Rubber/Magnetic License Plate Holder Combo.”

FlexyFrame LD (Light Duty) is a license plate frame that is made out of a rigid rubber that is flexible and resistant to various weather conditions.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a perspective view of the license plate frame;

FIG. 2 is a front view of the license plate frame of FIG. 1;

FIG. 3 is a back view of the license plate frame of FIG. 1;

FIG. 4 is a left side view of the license plate frame of FIG. 1;

FIG. 5 is a right side view of the license plate frame of FIG. 1;

FIG. 6 is a top view the license plate frame of FIG. 1; and,

FIG. 7 is a bottom view of the license plate frame of FIG. 1

FIG. 8 is a perspective view of the motorcycle license plate frame;

FIG. 9 is a front view of the motorcycle license plate frame of FIG. 8;

FIG. 10 is a back view of the motorcycle license plate frame of FIG. 8;

FIG. 11 is a left side view of the motorcycle license plate frame of FIG. 8;

FIG. 12 is a right side view of the motorcycle license plate frame of FIG. 8;

FIG. 13 is a top view the motorcycle license plate frame of FIG. 8; and,

FIG. 14 is a bottom view of the motorcycle license plate frame of FIG. 8.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

Disclosed is a durable weather resistant license plate frame that is made of silicone. The frame also features drainage holes for water to drain. The benefits of this disclosed frame are that the material allows the frame to be durable, not rattle, not rust, and not lose its shape under extreme weather conditions. More details of this disclosed frame are described with reference to the figures.

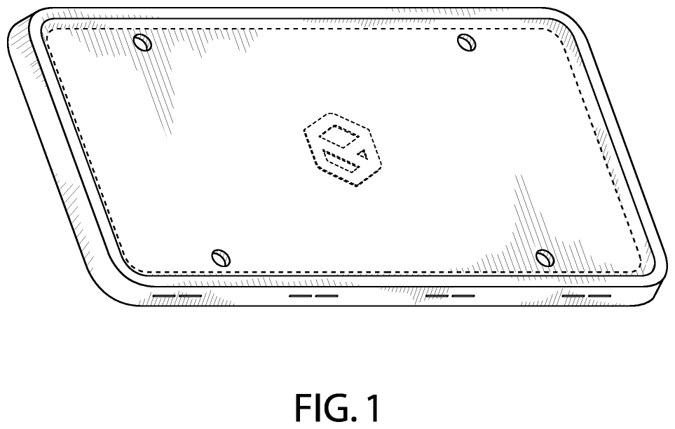

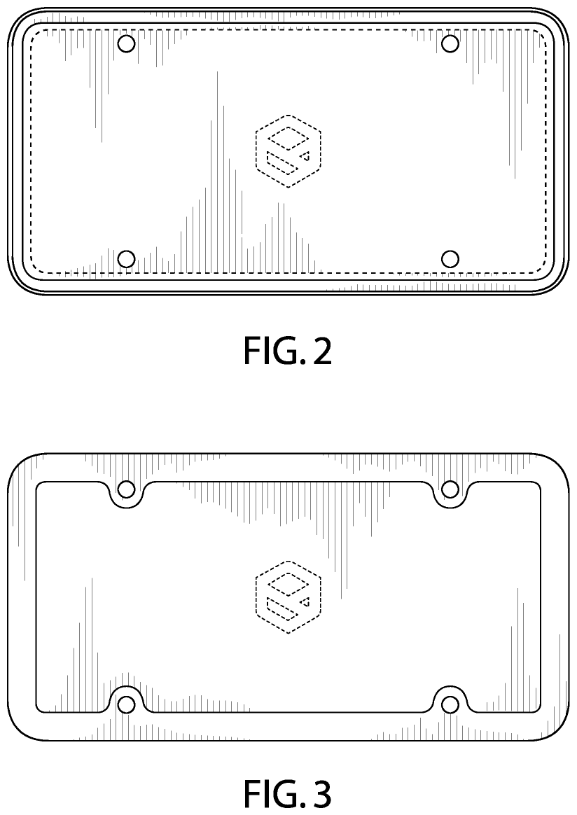

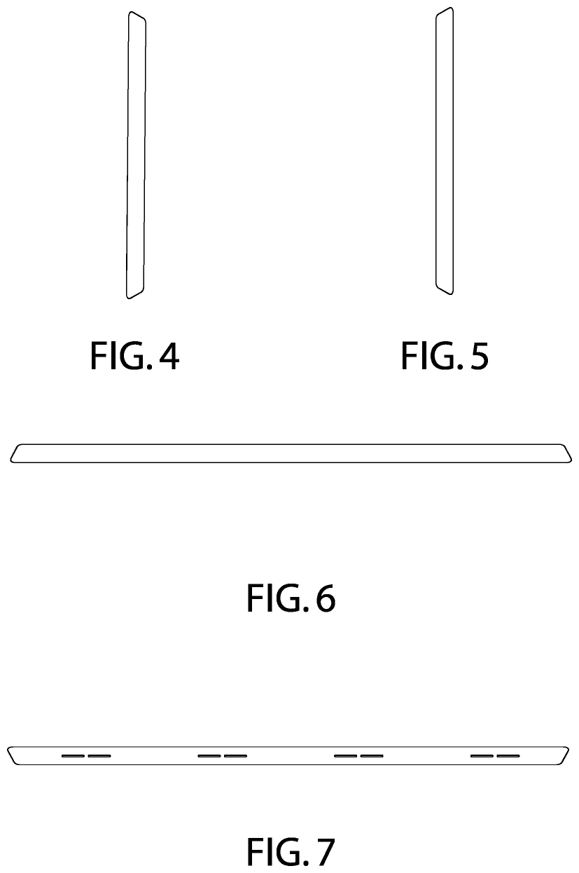

FIG. 1 is a perspective view of the license plate frame. As shown the frame is rectangular to accommodate standard, government issue license plates for automobiles (e.g., cars and trucks). Suitably the frame is constructed as an integral unit with a material backdrop that acts as a cushion between the plate and the vehicle to which the plate is attached. In use a plate is inserted into the frame after the silicone material is stretched over the edges. Suitably, the frame features drainage holes along one or more of the frame's side so that water or other fluid may drain out of the frame's pocket where the license plate is held. FIG. 2 is a front view of the license plate frame of FIG. 1. FIG. 3 is a back view of the license plate frame of FIG. 1. FIG. 4 is a left side view of the license plate frame of FIG. 1. FIG. 5 is a right side view of the license plate frame of FIG. 1. FIG. 6 is a top view the license plate frame of FIG. 1. FIG. 7 is a bottom view of the license plate frame of FIG. 1. It should be appreciated that the color of the frame can be customized to the look and appearance of the vehicle.

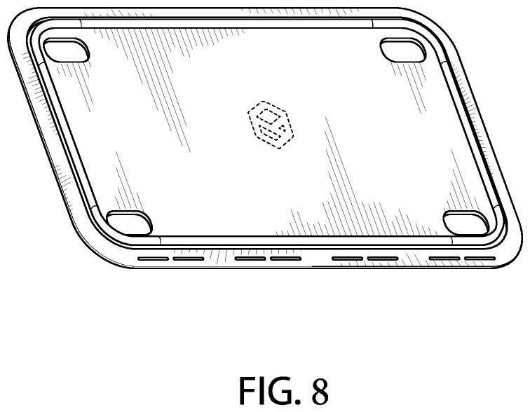

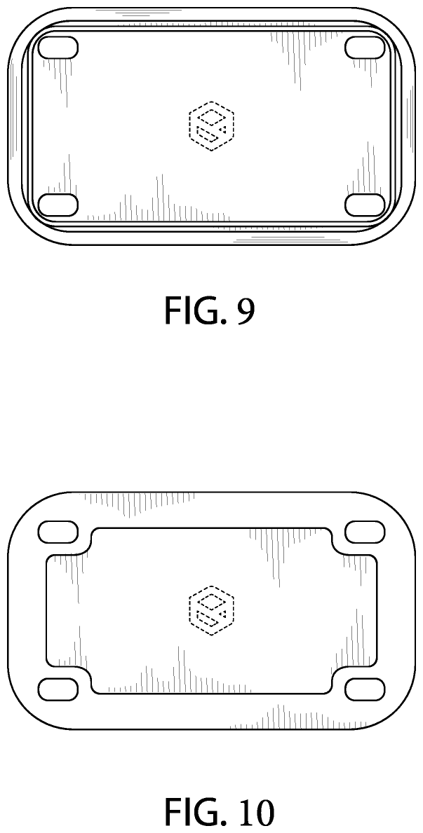

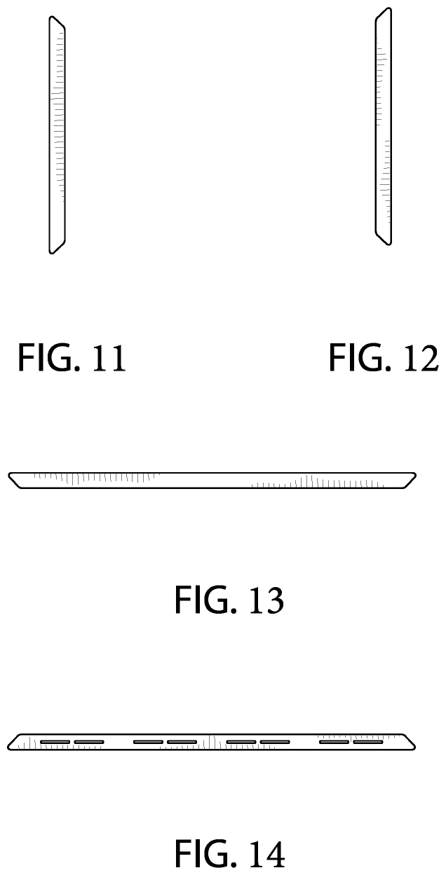

FIG. 8 is a perspective view of the motorcycle license plate frame. As shown the frame is rectangular to accommodate standard, government issue license plate for motorcycles. Suitably the frame is constructed as an integral unit with a material backdrop that acts as a cushion between the plate and the vehicle to which the plate is attached. In use a plate is inserted into the frame after the silicone material is stretched over the edges. Suitably, the frame features drainage holes along one or more of the frame's side so that water or other fluid may drain out of the frame's pocket where the license plate is held. FIG. 9 is a front view of the motorcycle license plate frame of FIG. 8. FIG. 10 is a back view of the motorcycle license plate frame of FIG. 8. FIG. 11 is a left side view of the motorcycle license plate frame of FIG. 8. FIG. 12 is a right side view of the motorcycle license plate frame of FIG. 8. FIG. 13 is a top view the motorcycle license plate frame of FIG. 8. FIG. 14 is a bottom view of the motorcycle license plate frame of FIG. 8. As before in the other embodiments, the color of the frame can be customized to the look and appearance of the vehicle.

Although the method and apparatus is described above in terms of various exemplary embodiments and implementations, it should be understood that the various features, aspects and functionality described in one or more of the individual embodiments are not limited in theft applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least” “but not limited to” or other like phrases in some instances shall not be read to mean that the narrowercase is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A durable weather resistant license plate frame that is made of silicone, said frame comprising:
Four sides and a back drop that are formed as a unit and that define a pocket for receiving a standard issue license plate.

2. The durable weather resistant license plate frame further comprising drainage holes.
